(19) United States
(12) Patent Application Publication
(10) Pub. No.: US 2015/0069133 A1
(43) Pub. Date: Mar. 12, 2015

(54) NANOTUBE PATTERNS FOR CHIPLESS RFID TAGS AND METHODS OF MAKING THE SAME

(71) Applicant: ZHENGFANG QIAN, KILDEER, IL (US)

(72) Inventor: ZHENGFANG QIAN, KILDEER, IL (US)

(21) Appl. No.: 14/020,897

(22) Filed: Sep. 9, 2013

(51) Int. Cl. G06K 19/02; G06K 19/067

(52) U.S. Cl. CPC G06K 19/02; G06K 19/067; G06K 19/022; B82Y 10/00
USPC 235/492; 427/58; 427/472; 977/742; 977/943

(57) ABSTRACT

Chipless RFID tags (200, 210, 220, 230, 240, 250, 260, 310, 320, 330, 400, 410, 420, 500, 510, 520, 600, 610, and 620) are designed and fabricated from the structures of the nanotube elements and their patterns on a dielectric substrate (202, 311, 401, and 501 etc.) by thin film coating or printing following by a polymer curing process.

Provisional Patent Application No.: 61/698,657 filed on Sep. 9, 2012

### FIELD OF THE INVENTION

The present invention is related to chipless RFID tags with use of nanotube antenna resonators and patterns and the methods of making same.

### BACKGROUND OF THE INVENTION

Radio Frequency Identification (RFID) has been widely used for automatic identification, asset tracking, supply chain management, counterfeiting of brand products, etc. Most of these RFID tags or transponders include a chip for storing the item information and a radio antenna for wireless communication or data transmission between the reader or the interrogator and the tag. Prior art of such tags can be illustrated in FIG. 1, from typical patents, for instance, U.S. Pat. No. 7,551,141 [1] and U.S. Pat. No. 6,265,977 [2]. The typical RFID tag 100 includes antenna elements 111, a semiconductor IC chip 112 of the resonant circuit with memory, and a substrate 113. There are various methods to attach the chip 112 to the antenna 111. The resonant antenna circuit can be formed either capacitively [1] or conductively [3].

The cost of the IC chip is high, comparing with traditional barcodes used billions each year. The chipped tag cost limits its huge applications and the replacement of the barcode. The optical barcode is usually printed on the paper substrate. It can carry multiple bits by ink strips and is extremely low cost. The limitations of optical barcodes are the line-of-sight, easy to be damaged, the short reading distance, and inaccurate, etc. On the other hand, two dimensional optical codes can be generated by an optical marking tag based on multiple diffraction gratings, for instance, U.S. Pat. No. 4,011,435 [4]. They also share the same limitations of the one-dimensional optical barcodes as described. The chipless tag is new category in the RFID family. The tag usually consists of multi-resonators [3] only without the IC chip. The tag responds wirelessly to an electromagnetic exciting radiation from the reader by transmitting, reflecting, or scattering mechanisms when the resonant conditions are satisfied. Fundamental principle of the wireless resonant or antenna is that the antenna element dimension is inversely proportional to its exciting wave length. For instance, the UHF (Ultra High Frequency) RFID tag works at the frequency band of 900 MHz. Its basic antenna length, i.e., half-wavelength, is 6 inches about 15 cm. In order to accommodate sufficient bits for item unique information, these tags with multiple resonators made from metal elements such as copper strips are very large in size. Therefore, only a few antenna elements are disclosed in the U.S. Pat. No. 6,997,388 [5] with traditional shapes and configurations. Specially, the fully-passive chipless tag working in microwave frequency bands has typical size from tens to hundreds of centimeters with only a few bits. It is not be satisfied for wide applications where the assets or items are small in volume or area. Therefore, current chipless RFID tags found very limited applications due to their limited bits or/and large size.

On the other hand, the dimension of antenna elements is bulky and still in macro-scale, typically, centimeter length and millimeter thickness. The fabrication methods are based on so-called top-down approach, for example, stamping from the metal foil. The thickness of antenna elements is limited by so-called skin depth due to RF loss requirements. The skin-depth is decreased by increasing the radio frequency, especially at millimeter wave frequency band (30˜300 GHz) and above. The skin effect becomes more of an issue and results in the loss of RF efficiency for these conventional solid and bulky antenna elements. It is desirable to provide novel materials such as nanotubes that can be almost no skin effect and extra RF loss when used as antennas or resonant elements without skin-depth limitation for applications in millimeter wave frequency bands and even Terahertz frequency bands.

As a result, there is also a strong demand and practical requirement for the RFID antennas or resonators that have much smaller dimensions for drug and food safety, jewelry and high brand products for anti-counterfeiting solutions. It is highly desirable that the antenna element or resonant works at much high radio frequencies such as millimeter frequency bands. The huge consumer market calls for the chipless tags that are capable of accommodating sufficient data bits with small size for item-level RFID applications. Finally, it needs to be manufactured by low cost technologies.

### BRIEF SUMMARY OF THE INVENTION

Present invention provides a unique solution for chipless RFID tags by using nanotubes as the resonator elements with different length and patterns. The sufficient bits can be achieved by the plurality of nanotube antennas or resonators with very small size in two-dimensional patterns or even one-dimensional patterns just like traditional barcodes. The radio frequencies of these nanotubes can reach millimeter wave range or tens to hundreds GHz frequency bands with each resonator element length from millimeters down to microns. Furthermore, the nanotube resonators can be fabricated by low-cost manufacturing methods such as printing technologies. The special fabrication substrate with the nanotube dispersion method is also disclosed in the embodiment of this invention. When the very low density of the nanotube resonants is achieved with disclosed patterns, the chipless RFID tag is small, transparent, and even invisible, making extra safety for anti-counterfeiting purposes physically.

### BRIEF DESCRIPTION OF THE DRAWINGS

The accompanying figures, where are incorporated in and form part of the specifications, serve to further illustrate various embodiments and to explain various principles and advantages all in accordance with the present invention. The foregoing aspects and the others will be readily appreciated by the skilled artisans from the following descriptions.

FIG. 1 illustrates a typical chipped RFID tag 100 with a semiconductor IC chip 112 as the digital information storage. At least one antenna with traditional metal elements 111 is necessary to receive the power from the reader and active the chip with the stored data. The same antenna can transmit the data back to the reader for identification. The carrier structure of the RFID tag is the substrate 113.

FIG. 2A are the patterns of the one dimensional nanotube antennas or resonators for the chipless RFID tag as the first exemplary embodiment. These nanotube resonator elements have the same or very close length with the same or different space between individual nanotubes.

FIG. 2B are another patterns of the one dimensional nanotube antennas or resonators for the chipless RFID tag as the second exemplary embodiment. The nanotube resonator elements have the different length patterns with the same or very close space between individual nanotubes.

FIG. 2C are yet another patterns of one dimensional nanotube antennas or resonators for the chipless RFID tag as the third exemplary embodiment. These nanotube resonator elements have the different patterns of both different lengths and different spaces between them.

FIG. 2D are yet other patterns of one dimensional nanotube antennas or resonators for the chipless RFID tag as the forth exemplary embodiment. These nanotube resonator elements have the any combined patterns disclosed in FIGS. 2A, 2B, and 2C.

FIG. 3A are the nanotube patterns of two-dimensional nanotube antennas or resonator elements for the chipless RFID tag as the exemplary embodiment. The first group of nanotube resonator elements is perpendicular to the second group of nanotube resonators or antenna elements. Each group can have the patterns as illustrated in FIGS. 2A, 2B, and 2C with different nanotube length or/and different space between tubes.

FIG. 3B are the another nanotube patterns of two-dimensional nanotube antennas or resonator elements for the chipless RFID tag as the exemplary embodiment. The first group of nanotube resonator elements is oriented in an angle to the second group of nanotube resonators or antenna elements. The angle is in a range from 0 to 180 degree. Each group can have the patterns as illustrated in FIGS. 2A, 2B, and 2C with different nanotube length or/and different space between tubes.

FIG. 3C are yet other nanotube patterns of two-dimensional nanotube antennas or resonator elements for the chipless RFID tag as the exemplary embodiment. The first group of nanotube resonator elements is oriented and stacked or overlapped in an angle to the second group of nanotube resonators or antenna elements. The angle is in a range from 0 to 180 degree. Each group can have the patterns as illustrated in FIGS. 2A, 2B, and 2C with different nanotube length or/and different space between tubes.

FIG. 4A are the nanotube patterns of two-dimensional nanotube antennas or resonator elements for the chipless RFID tag as the exemplary embodiment. The nanotubes are distributed randomly with the same or very close length.

FIG. 4B are the another nanotube patterns of two-dimensional nanotube antennas or resonator elements for the chipless RFID tag as the exemplary embodiment. The nanotubes are distributed randomly with the different tube length.

FIG. 4C are the other nanotube patterns of two-dimensional nanotube antennas or resonator elements for the chipless RFID tag as the exemplary embodiment. The nanotubes are distributed randomly by the different tube length and different orientations with a much dense tubes.

FIG. 5A are the nanotube patterns of two-dimensional nanotube antennas or resonator elements for the chipless RFID tag as the exemplary embodiment. The nanotubes are distributed with some local orders. The distributions are generated by an applied electric field to the mixture of nanotubes and liquid crystal host with a special dielectric index. The electrical return path is in the middle of the tag.

FIG. 5B are the another nanotube patterns of two-dimensional nanotube antennas or resonator elements for the chipless RFID tag as the exemplary embodiment. The nanotubes are distributed with the local orders. The distributions are generated by an applied electric field to the mixture of nanotubes and liquid crystal host with another dielectric index.

FIG. 5C are the other nanotube patterns of two-dimensional nanotube antennas or resonator elements for the chipless RFID tag as the exemplary embodiment. The nanotubes are distributed with the different local orders. The distributions are generated by an applied electric field to the mixture of nanotubes and liquid crystal host with certain dielectric index. The electrical return point is located in the anywhere of the tag. Multiple electrical return points can be located in the anywhere of the tag as illustrated.

FIG. 6A presents the dispersion method of the nanotube resonators into a liquid crystal solution randomly for the fabrication of one of chipless RFID tags as the exemplary embodiment. The liquid crystals serve as the carry media or host to separate the individual nanotube one from another effectively. The following curing step can be utilized to permanently frozen the nanotube patterns into a RFID tag, as described in FIGS. 4A, 4B, and 4C. The liquid crystal solution becomes a crystallized film as liquid crystal polymer that has been approved a high quality dielectric substrate for antennas with very low loss property [6]. This embodiment is the fabrication method of the nanotube resonators embedded into the liquid crystal polymer. Other similar media can be used for the fabrication process as long as the proper dielectric property is satisfied, which consists of yet another embodiment of present invention.

FIG. 6A also presents the alignment method of the nanotube resonators into a liquid crystal host by an applied field for the fabrication of the one of chipless RFID tags as the another exemplary embodiment. The liquid serves as the carry media to separate the individual nanotube one from another effectively. When a static electrical or magnetic field is applied cross the nanotube liquid crystal mixture, the nanotubes can be oriented by the liquid crystal molecules since their orientation can be tuned by the applied field. The field can be also increased by applied voltage through the proper device. Furthermore, following curing step can be utilized to permanently frozen the ordered nanotube patterns as illustrated in FIGS. 2A, 2B, 2C, and 2D. The applied electric field can be removed once the pattern has been frozen or fixed. The liquid crystal solution becomes the crystallized film as liquid crystal polymer that has been approved a high quality dielectric substrate for antennas with very low loss property [6]. This embodiment presents the fabrication method of ordered nanotube patterns of present invention.

FIG. 6B presents the patterns of two-dimensional nanotube antennas or resonator elements for the fabrication of one of chipless RFID tags as the exemplary embodiment by combining or repeating the regions disclosed in FIG. 6A.

FIG. 6C presents the more complicated patterns of two-dimensional nanotube antennas or resonator elements for the fabrication of one of chipless RFID tags as the another exemplary embodiment by combining or repeating the multiple regions in two directions disclosed in FIG. 6A.

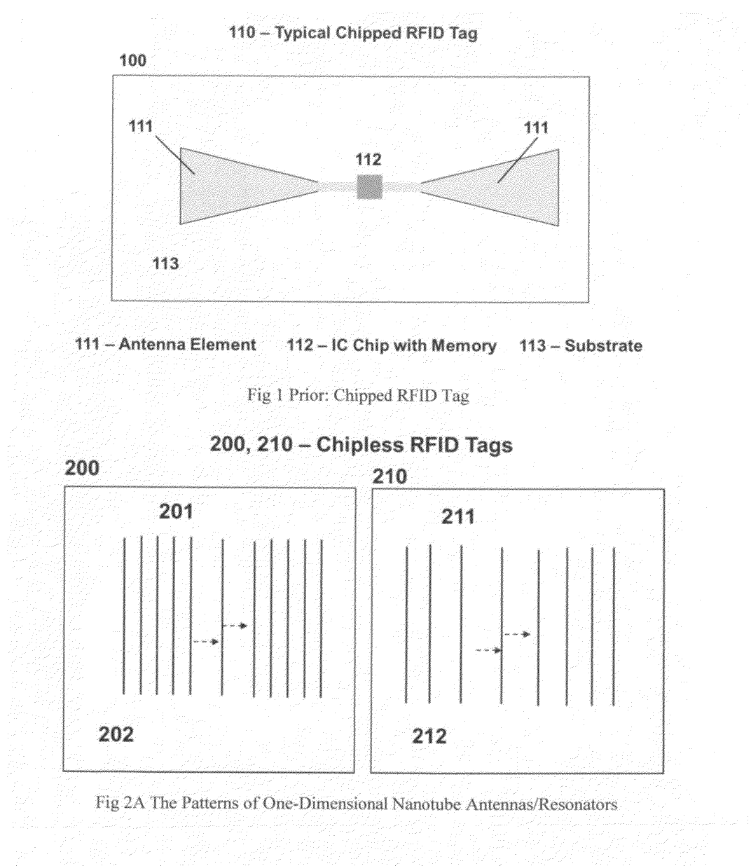

Skilled artisans will appreciate that elements or nanotubes in the figures are illustrated for simplicity and clarity and have not necessarily been drawn to actual scales. For instance, some of these nanotube elements in the figures may be exaggerated relatively to other elements to help to improve understanding of the embodiments of the present invention.

### DETAILED DESCRIPTION OF THE INVENTION

### Definitions

For the purpose of the disclosure and embodiments, the term “nanotube” in this invention is meant to include any high aspect ratio linear or curved nano-scaled structures, including single-walled, double-walled, and multi-walled nanotubes, semiconducting or conductive nanotubes, nanowires, nanotube bundles, nanotube yarns, nanowires, and nano-columns, and nano-beams which can be used as resonators or can be made to vibrate in an electrical or/and electromagnetic fields. These preferably have a length from 1 micron, to 1 millimeter, and to tens of centimeters, depending on the radio frequencies and the tag size requirements. The diameters have a width or diameter from 0.2 nm to 1 micron, and to tens of millimeters. Examples of the present nanotubes also include such metallic as Ni, Cu, Ag, and Au nanowires. Preferred carbon nanotubes have metallic or conducting properties with one, two, or multi-walls and directional or anisotropic conductivity.

For the purpose of present invention, the term “electromagnetic signal” is used to mean either electromagnetic waves moving through air or dielectric or electrons moving through wires or both in any a frequency or a frequency range.

For present disclosure, the term “radio” is used to mean the wireless transmission or communication through electromagnetic waves in any a frequency or a frequency range from 1 MHz to 1 GHz, and to 1 THz. Preferred millimeter waves are frequencies from 30 GHz to 300 GHz.

For present disclosure, the term “tag” is used to mean a layer of nanotube patterns and a substrate with any shape of an oval, a square, a rectangle, a triangle, a circle, or polygons, and any size from 1 micron to 1 millimeter, and to tens of centimeters. It can also be multi-layers with different nanotube patterns and substrate materials.

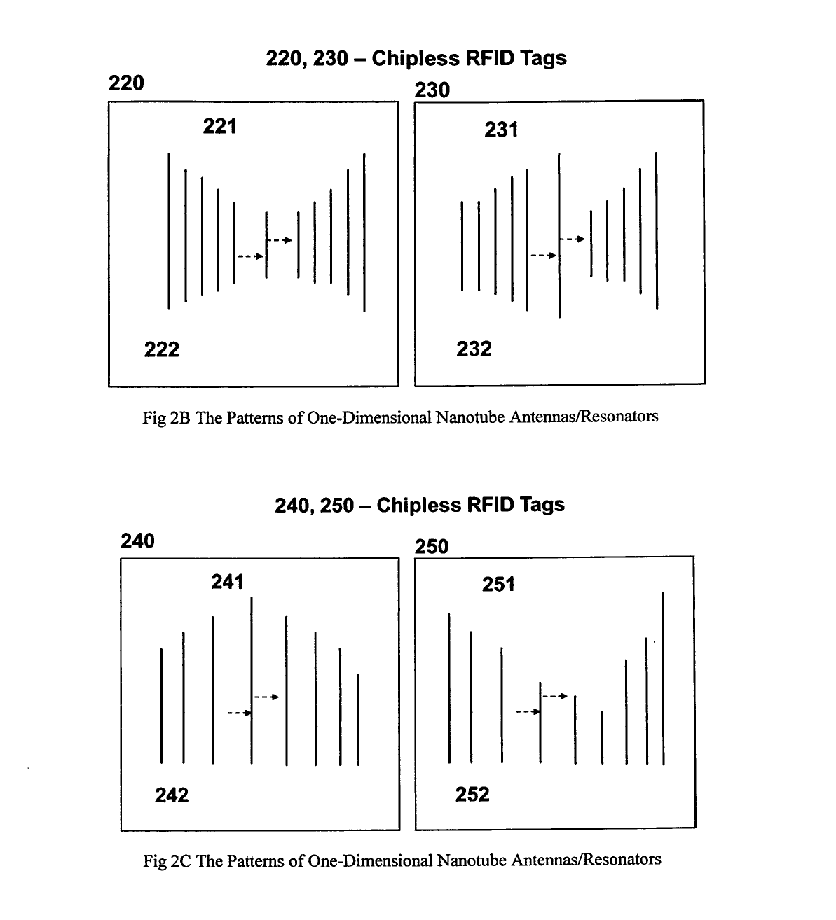

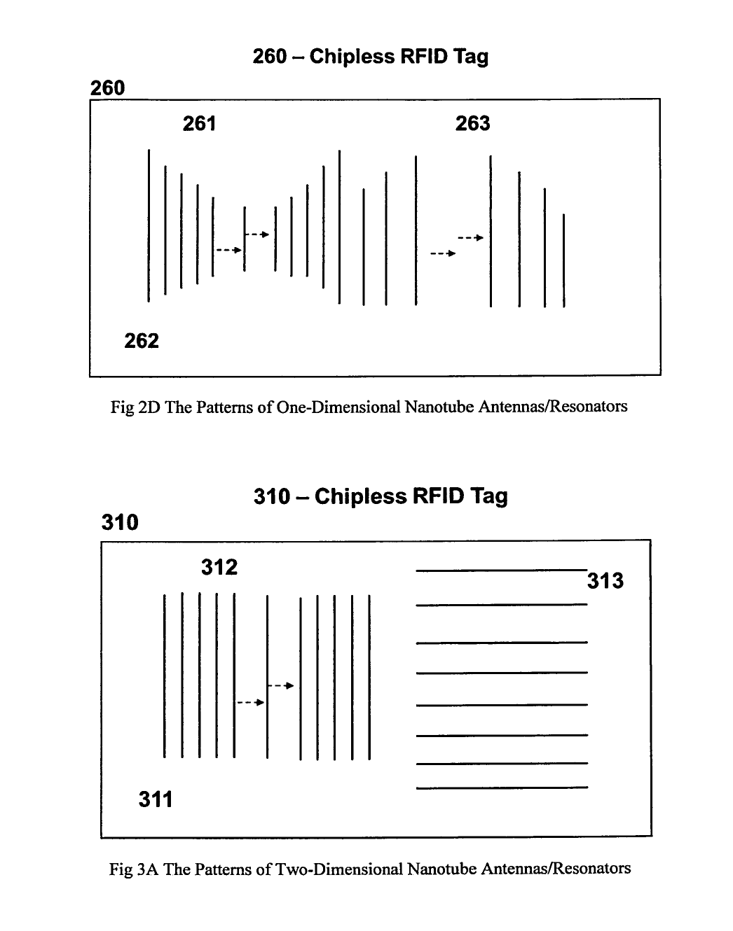

FIG. 2A describes the embodiment of present invention of the patterns of one-dimensional nanotube antennas or resonator elements. The chipless tags 200 and 210 are formed in the substrates 202 and 212 respectively. In the first tag 200, the nanotubes have the very close or the same length with the same space between the two elements. Therefore, under the incoming electromagnetic wave radiation, the nanotubes are excited and re-radiated in a certain frequency correlated to the nanotube length. A diffraction pattern from the nanotube pattern can be received by a remote receiver device. The pattern 211 is different from the pattern 201 by that the space between the two nanotubes can be changed and different from one to another. Therefore, different diffraction patterns are formed with the same frequency but different phase angles. The RF characteristics can be used for coding and decoding. We will disclose the coding and decoding methods based on nanotube patterns in another patent disclosure [7].

FIG. 2B describes the embodiment of present invention of the patterns of one-dimensional nanotube antennas or resonator elements. The chipless tags 220 and 230 are formed in the substrates 222 and 232 respectively. In the tags 220 and 230, the nanotube patterns 221 and 231 have different length and shapes which can be formed by printing the nanotube ink or cutting or stamping the nanotube pattern 201. The different length patterns will generate different diffraction patterns with different frequencies or a broadband spectrum under the incoming electromagnetic radiation. The broadband diffraction patterns from the nanotube patterns can be received by a remote receiver device and utilized for enhancing the codes or bits disclosed in another patent disclosure [7].

FIG. 2C describes the embodiment of present invention of the other patterns of one-dimensional nanotube antennas or resonator elements. The chipless tags 240 and 250 are formed in the substrates 242 and 252 respectively. In the tags 240 and 250, the nanotube patterns 241 and 251 have different length, different spacing, and different shapes. These pattern features can be formed by printing the nanotube ink or cutting or stamping the nanotube pattern 211. The tag 260 presents a plurality of nanotube patterns by any combinations of the previous patterns of 201, 211, 221, 231, 241, and 251. The plenty of various different diffraction patterns with broadband and a wide phase difference can be generated once the RFID reader radiates the electromagnetic radiation on the tags. A remote receiver device can utilize the information patterns for obtaining sufficient number of codes or bits for the RFID detection disclosed in another patent disclosure [7].

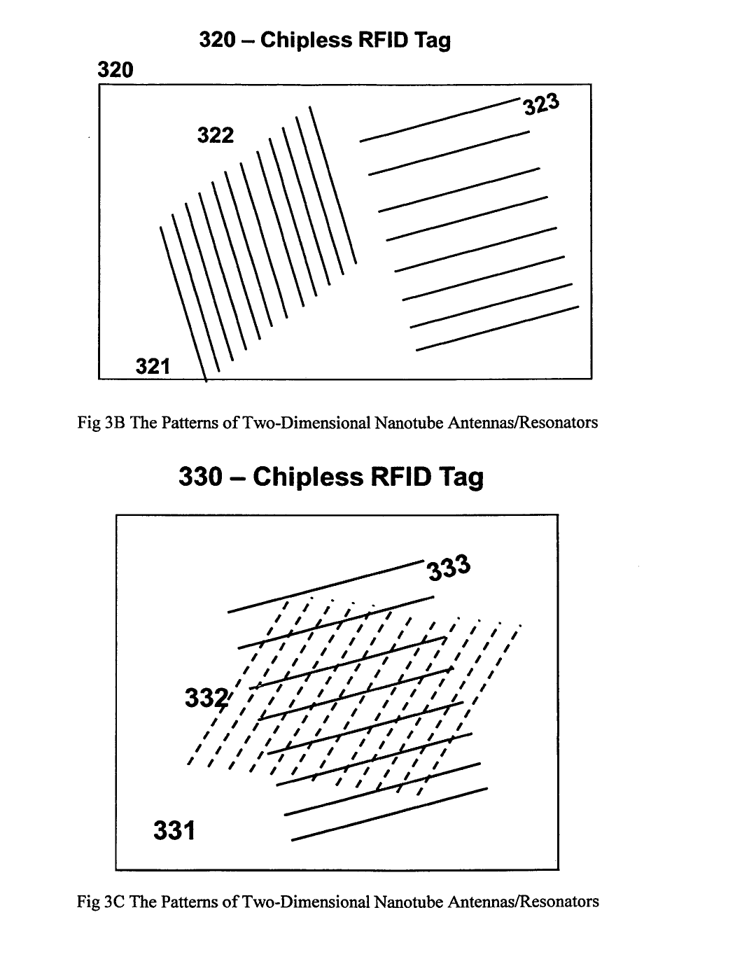

FIG. 3A describes another embodiment of present invention of patterns of the two dimensional nanotubes. The tag 310 presents a plurality of nanotube patterns by combinations of the previous 201 (now 312) and 211 (now 313) in a 90 degree angle on the substrate 311, for instance. FIG. 3B discloses the two dimensional patterns by angling the group 322 and group 323 of nanotubes. In the FIG. 3C, the two dimensional nanotube patterns are formed by stacking one pattern 333 on the pattern 332 in any angle from 0 to 180 degrees according to the embodiment of current invention. The advantages are such pattern fabrication is at least double of the frequency spectrum and much wider the phase difference. If the same bits are required, the tag size can be at least 4 times smaller, comparing with the patterns in FIG. 3B. Again, a remote receiver device can utilize the diffraction information patterns for obtaining sufficient number of codes or bits and the small size of tags for the RFID detection disclosed in another patent disclosure [7].

As such, nanotube elements 312, 322, or 332 can be excited and resonating, provide a series of radio frequencies in responding to their excitation frequency spectrum in one direction. The second group of the nanotube elements 313, 323, or 333 can provide another series of radio frequencies in responding to their excitation frequency spectrum in another direction. RF (Radio Frequency) responsiveness in principle from any nanotube element can be radiation, reflection, and scattering. The two groups of elements can be oriented by any combinations from an angle from 0 to 180 degrees. Therefore, a very complicated directional RF patterns can be formed. The RF receiver can collect these responsiveness properties with different patterns selectively or collectively. Large number of digital bits is formatted by coding and decoding technologies [7] based on their RF responsiveness properties that can be two-dimensional and even three dimensional patterns, as disclosed in present invention.

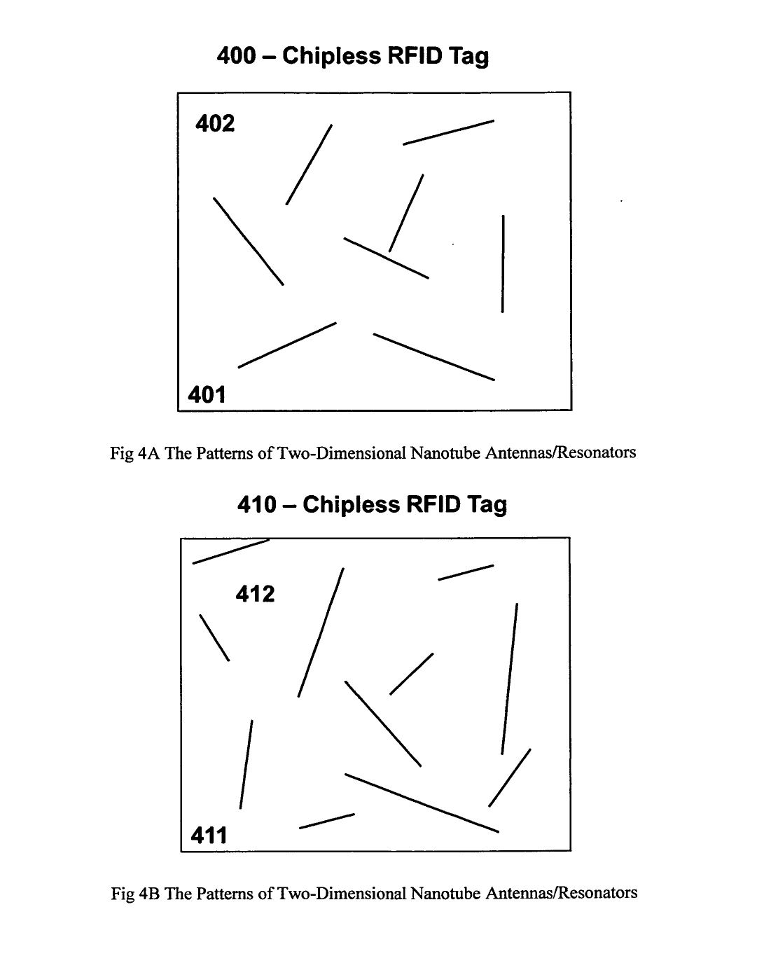

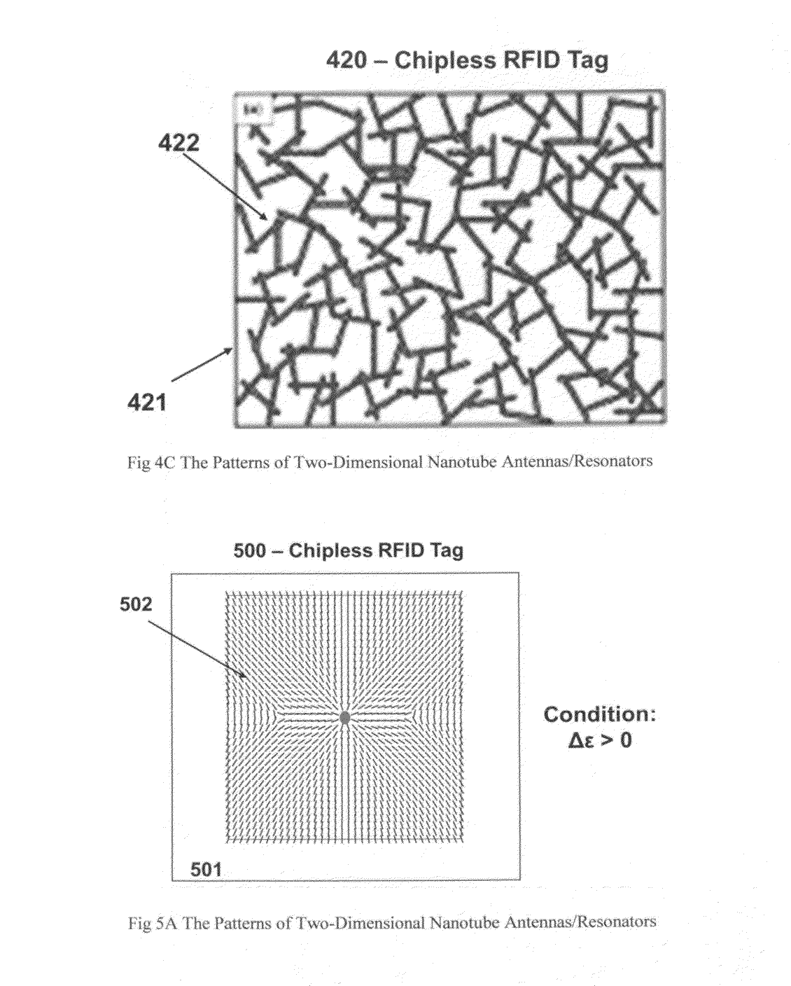

FIGS. 4A, 4B, and 4C are the nanotube patterns of two-dimensional nanotube antennas or resonator elements for the chipless RFID tags where the nanotubes are distributed randomly with the same length 402, different length 412, and 422. A very wide frequency spectrum can be generated with a broadband phase signature for the coding and decoding of the chipless RFID disclosed in another patent disclosure [7]. The fabrication method is also disclosed in present patent. The nanotubes are distributed randomly by the different tube length and different orientations with a tube volume percentage from as low as 0.01% to 10%. As such, millions of patterns and codes can be generated both physically and digitally for RFID tag security. Protected and unique software can be provided to customers for the secured identification of brand products to protect their high value products for counterfeiting purpose.

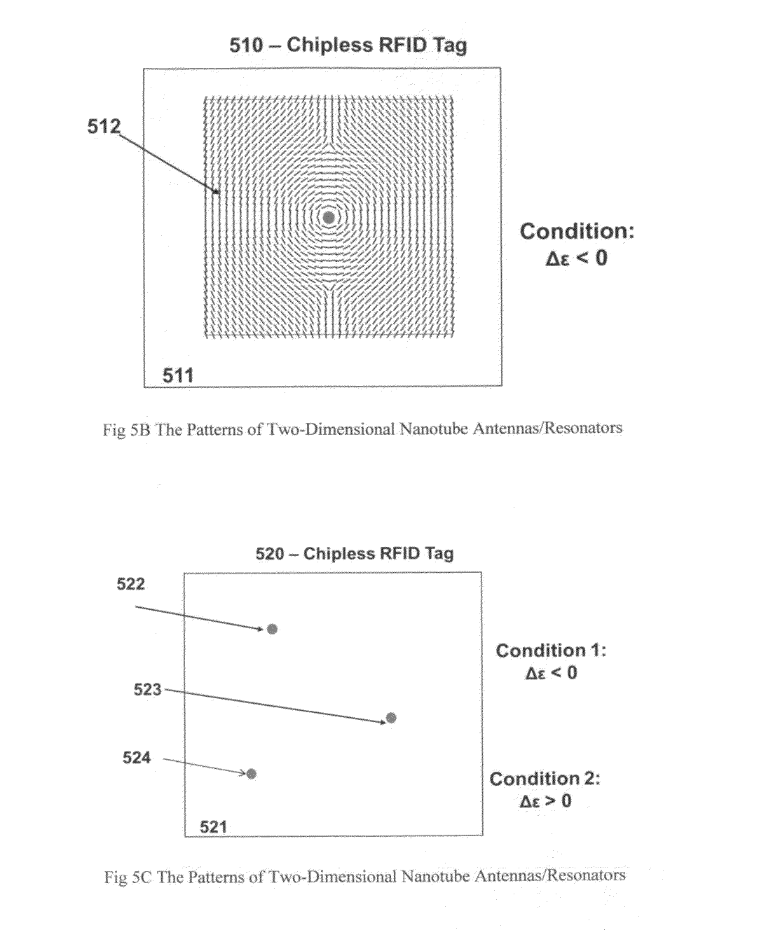

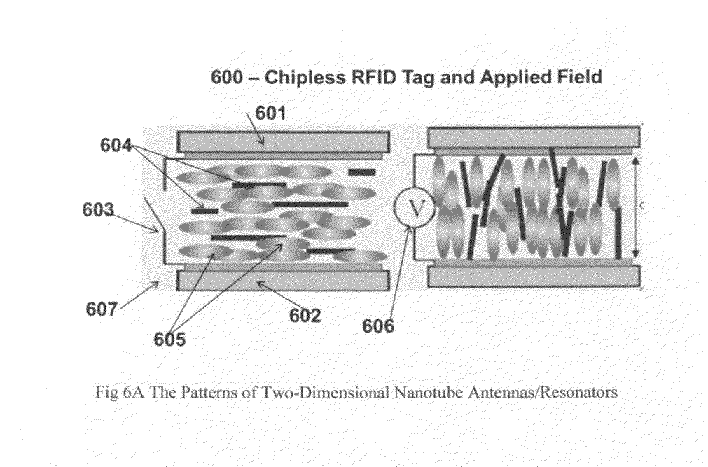

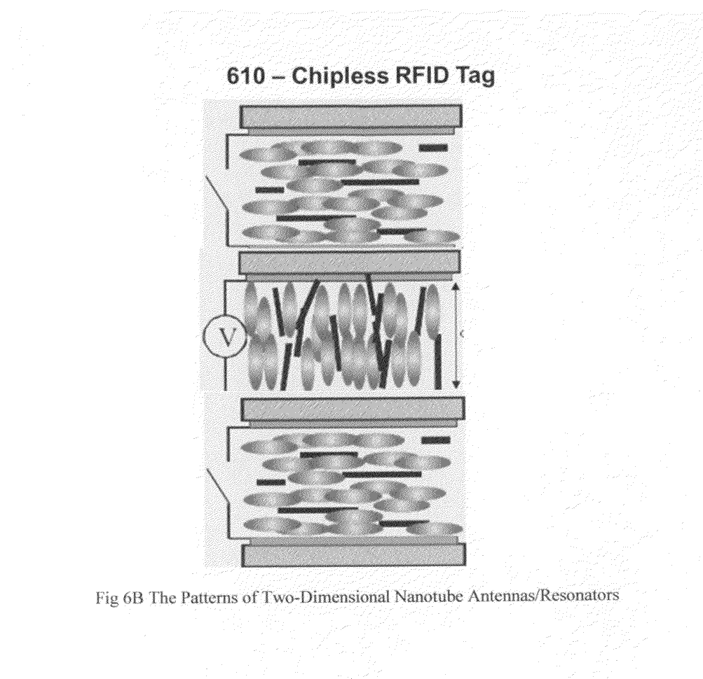

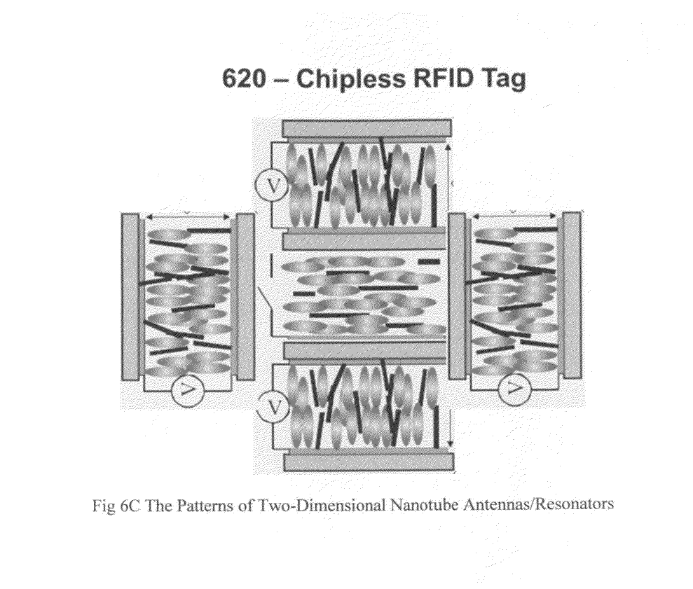

FIGS. 5A and 5B present the dispersion method of the nanotube elements into a liquid crystal solution host. Liquid crystals have several basic phases, which are widely used for various display devices. A liquid crystal, e.g., nematic phase, has shown to be good host for carbon nanotubes' dispersion effectively [6, 8, 9, 10]. The liquid crystal host 605 illustrated in FIG. 6A is made of elongated molecules with anisotropic properties. The liquid 605 serves as the carry media to separate the individual nanotube element 604 one from another. The nanotube tags 400, 410, and 420 can be processed in two-steps basically. The first step is the mixing and dispersion of nanotube elements 402, 412, 422 with the liquid crystal host 605 with the certain ratio or percentage of the nanotube elements. The mixing percentage can be a range from 0.01 percent to 10 percent, depending on the complexity and bits level requirements. After the proper formation of the nanotube elements' solution, the second step can be a thin coating, screen printing, or alternative printing techniques, followed by a curing process to fabricate the nanotube tag into the very thin liquid crystal polymer substrate 401, 411, or 421. It can be transparent and even invisible since a very thin liquid crystal polymer is formed and the nanotube is well dispersed in a very low percentage. This embodiment of the tag processing can fabricate the tags 400, 410, 420 etc. with unique codes, transparent and invisible film substrates as well as low-cost fabrication methods such as printing. Furthermore, the tags can be attached or embedded into the small products for RF identification with high security for preventing the tag replaced or/and faked by any third party. Alternative media or host liquids can be used for the same or similar fabrication processes as long as the proper dielectric property of the substrate made from the host liquid is satisfied for RFID purpose, which consists of yet another embodiment of present invention.

Another fundamental function, so-called Freederick transition of the liquid crystals needs to be utilized for the fabrication purpose. A collective reorientation of the liquid crystal directors can be achieved by applying an electric field 606 [8,9,10]. The strength of the applied electric field can be controlled by the device 603 and 606 using the electrical high voltage. It has been shown that the nanotube elements can be well-aligned and controlled by the applied electric field with the sufficient field strength [8,10] that is furthermore controlled by the device 603. The nanotube element tags 500, 510, 520, and 600 with specific orientation distribution of different orders inside local areas can be processed in four basic steps. The first step is the mixing and dispersion of nanotube elements with the liquid crystal host to form the mixture 502 or 512 with the certain ratio or percentage of the nanotube elements. The mixing percentage can be a range from 0.01 percent to 10 percent, depending on the requirements of the complexity and bits. After the proper formation of the nanotube elements' solution can be coated, screen printed, or distributed uniformly in an area for fabricating the nanotube tags. The electric field is applied as the third step, which can be realized by immersing a conductive structure with one positive pole 601 and another negative pole 602 into the area. The final step is the curing process to fabricate the nanotube tags 500, 510, 520 and 600. A very thin liquid crystal polymer substrate with the designed patterns of nanotube elements is fabricated by the described process steps. The fabrication of the tag 610 can be repeated from one area to another area. Multiple tags can be fabricated at the same time using a conductive structure pattern that is designed as the FIG. 6(c) for tag 620. The conductive structure is to be removed after the tag fabrication. There is no limitation for designing the innovative patterns disclosed in present invention. The embodiment should cover all these pattern variations in different shapes and sizes. The tags as fabricated in the embodiments can be transparent and even invisible since a very thin liquid crystal polymer is formed and the nanotube is well dispersed in a very low percentage and oriented in one or more designed patterns. These embodiments of the tag processing can fabricate the tags into unique codes, transparent, invisible with the low cost. Furthermore, the tags can be stamped into different shapes for encoding and attached or embedded into the products for RF identification with high security for preventing the tag replaced or/and faked by any third party.

### REFERENCES

[1] U.S. Pat. No. 7,551,141, Hadley et al., RFID Strap Capacitively Coupled and Method of Making Same, Jun. 23, 2009

[2] U.S. Pat. No. 6,265,977, Vega et al., Radio Frequency Identification Tag Apparatus and Related Method, Jul. 24, 2001.

[3] U.S. Pat. No. 6,424,263, Lee et al., Radio Frequency Identification Tag On a Single Layer Substrate, Jul. 23, 2002.

[4] U.S. Pat. No. 4,011,435, Phelps et al., Optical Indicia Marking and Detection System, Mar. 8, 1977.

[5] U.S. Pat. No. 6,997,388, Yogev et al., Radio frequency data carrier and method and system for reading data stored in the data carrier, Feb. 14, 2006.

[6] Lapointe et al., Elastic Toque and the Levitation of Metal Wires by a Nematic Liquid Crystal, Science, Vol303, January 2004, pp. 652-655.

[7] Zhengfang Qian, Patent Application: Coding and Decoding Methods of Nanotube Chipless RFID Tags.

[8] Onuki A., Liquid Crystals in Electric Field, J Physical Society of Japan, Vol73, March 2004, pp. 511-514.

[9] Jeon et al., Dynamic Response of Carbon Nanotubes Dispersed in Nematic Liquid Crystal, NANO: Brief Reports & Reviews, Vol2, 2007, pp. 41-49.

[10] Dierking I et al., Liquid Crystal-carbon nanotube dispersions, J Applied Physics, Vol. 97, 044309, 2005, pp. 1-5.

What is claimed is:

1. A chipless RFID tag comprising:
a structure of nanotube elements that can be any hollow conductors and a substrate as the host of the nanotube elements where the dimension of each element of the order of a wavelength of RF radiation, reflection, or diffraction to produce a RF response in a form of radiation, reflection, or diffraction patterns which can be used for coding and decoding digital bits for identification with security

2. The structure of the nanotube elements according to claim 1 is distributed regularly in various one-dimensional patterns as embodiments

3. The structure of the nanotube elements according to claim 1 is distributed randomly in various patterns as embodiments.

4. The structure of the nanotube elements according to claim 1 is distributed in two directions in an angle from zero to 180 degrees

5. The structure of the nanotube elements according to claim 1 is stacked or overlapped in two directions in an angle from zero to 180 degrees to form various patterns

6. The structure of the nanotube elements according to claim 1 is the combination of one directional regular pattern in the claim 2 in an angle with the structure randomly distributed according to the claim 3.

7. The structure of the nanotube elements according to claim 1 is two dimensional patterns formed by an applied electrical field on the any nanotube and liquid crystal polymer mixture

8. The structure of the nanotube elements according to claim 1 is any structural combination of embodiments in Figures disclosed in this invention.

9. The substrate according to claim 1 is the liquid crystal polymer.

10. The substrate according to claim 1 is the any dielectric film.

11. The nanotube element according to claim 1 is the resonator.

12. The fabrication of the RFID tag from claim 1 is the nanotube elements in liquid crystal polymer substrate by thin-film coating and crosslink curing of nanotube elements and liquid crystal mixture solution.

13. The RFID tag at claim 1 is fabricated by screen-printing, inject printing, gravure printing, offset printing etc. followed by the electrical field alignment and crosslink said polymer solution.

14. The electrical field is controllable by the electrodes of positive and negative as well the voltage of any required values

15. The electrical field and electrodes according to claim 14 are removed after the said RFID tag fabrication.
